(19) United States
(12) Patent Application Publication
(10) Pub. No.: US 2025/0253757 A1
(43) Pub. Date: Aug. 7, 2025

(54) MULTI-PHASE POWER CONVERTER AND METHOD OF CONTROLLING THE SAME

(71) Applicant: DELTA ELECTRONICS, INC., Taoyuan City (TW)

(72) Inventor: Shang-Kay YANG, Taoyuan City (TW)

(21) Appl. No.: 19/184,270

(22) Filed: Apr. 21, 2025

Related U.S. Application Data
(63) Continuation of application No. 18/300,190, filed on Apr. 13, 2023.
(63) Continuation of application No. 18/425,763, filed on Jan. 29, 2024.

(30) Foreign Application Priority Data
Nov. 25, 2022 (CN) 202211490928.3
Sep. 4, 2023 (CN) 202311129940.6

(51) Int. Cl. H02M 1/00; H02M 1/08; H02M 1/42

(52) U.S. Cl. CPC H02M 1/0054; H02M 1/0035; H02M 1/08; H02M 1/4233

(57) ABSTRACT

A multi-phase power converter converts an input voltage into an output voltage to supply power to a load, and the multi-phase power includes at least two power conversion circuits, a driver circuit and a controller. The controller is configured to determine a loading condition of the multi-phase power converter according to at least one of an input current and an output current of the multi-phase power converter. When the controller determines the loading condition is not a heavy-loading condition, the controller configures the driver circuit to alternatively drive the power conversion circuits to converter the input voltage into the output voltage; the controller disables the driver circuit when the input current of the multi-phase power converter is lower than a predetermined threshold, and the controller enables the driver circuit to alternatively drive the power conversion circuits when the input current is greater than the predetermined threshold.

### CROSS-REFERENCE TO RELATED APPLICATIONS

This application is a continuing application of U.S. patent application Ser. No. 18/300,190 filed on Apr. 13, 2023 which claims priority to China patent application Ser. No. 202211490928.3 filed on Nov. 25, 2022, and is a continuing application of U.S. patent application Ser. No. 18/425,763 filed on Jan. 29, 2024 which claims priority to China patent application Ser. No. 202311129940.6 filed on Sep. 4, 2023. The entire disclosures of the above applications are all incorporated herein by reference.

### BACKGROUND

### Technical Field

The present disclosure relates to a multi-phase power converter and a method of controlling the same, and more particularly to multi-phase power converter with at least two switch bridge arms alternately driven and a method of controlling the same.

### Description of Related Art

The statements in this section merely provide background information related to the present disclosure and do not necessarily constitute prior art.

In recent years, with the rapid development of the information industry, power supplies have become an indispensable key role. As the power demand of large information equipment gradually increases, the output power of the power supply also gradually increases due to the increase in load demand.

When the power of a single power supply is sufficient, the front-end AC-to-DC converter usually adopts a single power factor correction (PFC) structure. However, when the overall power of the system increases, the disadvantages will become apparent so that more parallel-connected power supplies are needed to meet the demand. When an N-phase power conversion structure is used, in order to acquire higher efficiency, only one phase will operate when the load is light (i.e., in a light-loading condition), and it will fully start when the load gradually increases to a certain level.

The AC-to-DC (alternating current/direct current) converter uses a circuit structure with upper and lower arm switches. If the drive circuits of driving the upper and lower fast-switching arms use independent power supplies, under a lighter loading condition, other phases will be turned off, and the upper-arm drive power source will remain greater than the UVLO (undervoltage-lockout) state of the drive IC. This design is suitable for use when the power supply supplies a heavy load momentarily from no load or light load. As shown in FIG. 1, two power conversion structures are as an example, that is, the multi-phase power converter includes a first power conversion circuit 91 and a second power conversion circuit 92. When the drive circuits of driving the upper and lower fast-switching arms use independent power supplies, a total input current I_{IN}, a first input current I_{IN1} flowing into the first power conversion circuit 91, and a second input current I_{IN2} flowing into the second power conversion circuit 92 are as shown in the FIG. 2, which shows a schematic current waveform diagram of operating upper and lower drive circuits of the related-art power supply by independent power supplies. For the first power conversion circuit 91 and the second power conversion circuit 92 independently controlled, in the current waveform diagram shown in FIG. 2, under the light-loading condition (i.e., before time t1), the first power conversion circuit 91 operates (drives), while the second power conversion circuit 92 is idle. When the power supply momentarily provides a heavy load from no load or light load (i.e., after time t1), since the DC driving voltage Vcc for the drive IC is greater than the UVLO voltage, the second power conversion circuit 92 does not require the time of charging the upper arm, and the upper and lower arm switches can immediately work normally. In this condition, there will be no instantaneous large current stress. However, using independent power supplies will increase the size and cost of the circuits.

When the drive circuits of driving the upper and lower fast-switching arms use a single power supply, a diode is usually added to the DC driving voltage Vcc (i.e., the upper arm power supply). When the lower arm is turned on, the upper arm capacitor is charged though the diode in the forward direction. If the voltage of the upper arm capacitor is lower than the UVLO voltage of the drive IC, the upper arm drive signal will be forcibly turned off. Under the light-loading condition, only one phase power conversion is used to increase efficiency, and other phases are forced to stand by. However, when the loading suddenly increases, all phases must be turned on, including the phases that were originally forced to stand by. However, since the voltages of the upper arm capacitors may be lower than the UVLO voltage of the drive

IC, their upper arm drive signals will be forcibly turned off, which may not be able to provide enough energy, resulting in a lower output voltage. As shown in FIG. 3, which shows a schematic current waveform diagram of operating upper and lower drive circuits of the related-art power supply by a single power supply. Although the voltage of the upper arm drive signal Vcc can be maintained by turning on the lower arm switch during standby to prevent it from falling below the UVLO voltage, it also has a side effect affecting the total harmonic distortion of the current. Since the lower arm must be forced to be turned on, the total input current I_{IN} must provide the second input current I_{IN2}. However, since the role of the second input current I_{IN2} is only to maintain the voltage Vcc of the upper arm drive signal, the burst mode is generally adopted. In a short period of conduction, the upper arm drive power supply has the sufficient driving voltage Vcc. However, the current quality of the total input current I_{IN} will be degraded.

Moreover, when the general power converter with power factor correction function is under no load, in order to maintain the output voltage, the magnitude of the PWM signal follows the control value of the controller (as shown in FIG. 4). When the instantaneous value of the input voltage appears at a lower input voltage Vin (usually near the zero-crossing point), the energy transferred will be very low (i.e., Vin(wt)*Iin). The power converter needs to output more pulses (corresponding to the inductor current Il) to stabilize the output voltage Vout, resulting in increased driving loss of the power converter. Similarly, since the power converter needs to output more pulses when the instantaneous value of the input voltage appears at a lower input voltage Vin, the conversion efficiency of the current power converter will be poor, and additional power consumption will be increased.

Therefore, how to design a multi-phase power converter and a method of controlling the same to solve the problems and technical bottlenecks in the existing technology has become a critical topic in this field.

### SUMMARY

An objective of the present disclosure is to provide a multi-phase power converter. The multi-phase power converter converts an input voltage into an output voltage to supply power to a load, and the multi-phase power includes at least two power conversion circuits, a driver circuit and a controller. Each of the power conversion circuit includes a switch bridge arm formed by an upper switch and a lower switch connected in series. The driver circuit is coupled to and configured to drive the upper switches and the lower switches of the power conversion circuits to convert the input voltage into the output voltage. The controller is coupled to the driver circuit and is configured to determine a loading condition of the multi-phase power converter according to at least one of an input current and an output current of the multi-phase power converter for providing control signals for the upper switches and the lower switches of the power conversion circuits. Wherein when the controller determines the loading condition is a heavy-loading condition, the controller configures the driver circuit to drive the power conversion circuits to simultaneously converter the input voltage into the output voltage. Wherein when the controller determines the loading condition is not the heavy-loading condition, the controller configures the driver circuit to alternatively drive the power conversion circuits to converter the input voltage into the output voltage. The controller disables the driver circuit when the input current of the multi-phase power converter is lower than a predetermined threshold, and the controller enables the driver circuit to alternatively drive the power conversion circuits when the input current is greater than the predetermined threshold.

Another objective of the present disclosure is to provide a method of controlling a multi-phase power converter. The multi-phase power converter includes at least two power conversion circuits and a driver circuit, and each of the power conversion circuit comprising a switch bridge arm formed by an upper switch and a lower switch connected in series. The method includes: driving the upper switch and the lower switch of the power conversion circuit by the driver circuit to convert the input voltage into the output voltage; determining a loading condition of the multi-phase power converter according to at least one of an input current and an output current of the multi-phase power converter for providing control signals for the upper switches and the lower switches of the power conversion circuit; configuring the driver circuit to drive the power conversion circuits to simultaneously converter the input voltage into the output voltage when determining that the loading condition is a heavy-loading condition; and configuring the driver circuit to alternatively drive the power conversion circuits to converter the input voltage into the output voltage when determining that the loading condition is not the heavy-loading condition; disabling the driver circuit when the input current of the multi-phase power converter is lower than a predetermined threshold; enabling the driver circuit to alternatively drive the power conversion circuits when the input current is greater than the predetermined threshold.

Accordingly, the present disclosure has the following features and advantages:

1. The driving circuit of the multi-phase power converter of the present disclosure uses a single power supply so that it is beneficial to the miniaturized circuit design and cost reduction.

2. The total harmonic distortion of the total input current is significantly reduced, which increases the current quality.

3. The multi switch bridge arms are driven alternately, and each with an average conduction/turned-on time so that the power loss is also average. Moreover, the temperatures of the switch transistors are more even. In addition to the design that helps with heat dissipation and cooling, it is also less likely to cause a large difference in life due to imbalance in usage time.

4. When the load is light to a certain extent (i.e., no load or light load), the method of burst control of the output voltage (i.e., the burst mode) is used to make the input current reach near the peak value of the input voltage so that when the input current reaches near the peak value of the input voltage, the driver circuit is enabled. Therefore, the controller may only operate the switching of the power switches when the driver circuit is enabled so that the energy stored in the inductor can be effectively transferred to the output capacitor. Especially when the power factor correction circuit is under no-load condition or light-load condition, and the input current is not high, the effect is even more remarkable. Therefore, the power converter and its operating method of the present disclosure can achieve the effect of increasing the efficiency of the power factor correction circuit and reducing the driving loss of the power factor correction circuit when it is under no-load operation or light-load operation.

It is to be understood that both the foregoing general description and the following detailed description are exemplary, and are intended to provide further explanation of the present disclosure as claimed. Other advantages and features of the present disclosure will be apparent from the following description, drawings and claims.

### BRIEF DESCRIPTION OF DRAWINGS

The present disclosure can be more fully understood by reading the following detailed description of the embodiment, with reference made to the accompanying drawing as follows:

FIG. 1 is a block circuit diagram of a related-art multi-phase power converter.

FIG. 2 is a schematic current waveform diagram of operating upper and lower drive circuits of the related-art power supply by independent power supplies.

FIG. 3 is a schematic current waveform diagram of operating upper and lower drive circuits of the related-art power supply by a single power supply.

FIG. 4 is a waveform diagram of power factor correction of a conventional power converter.

FIG. 5 is a block structure diagram of a multi-phase power converter according to the present disclosure.

FIG. 6 is a circuit diagram of the multi-phase power converter having two switch bridge arms according to the present disclosure.

FIG. 7 is a circuit diagram of the multi-phase power converter having three switch bridge arms according to the present disclosure.

FIG. 8 is a circuit diagram of the multi-phase power converter having a Totem-Pole power factor correction circuit according to the present disclosure.

FIG. 9 is a schematic current waveform diagram of alternately driving switch bridge arms of the multiple-phase power converter according to the present disclosure.

FIG. 10 is a flowchart of a method of controlling the multi-phase power converter according to the present disclosure.

FIG. 11A is a block circuit diagram of a power converter with reduced power consumption according to the present disclosure.

FIG. 11B is a schematic diagram of power consumption reduction of the power converter according to the present disclosure.

FIG. 12 is a block circuit diagram of a controller according to the present disclosure.

FIG. 13 is an operation sequence diagram of the power converter according to the present disclosure.

FIG. 14 is a curve diagram of a conduction phase angle interval of an input current according to the present disclosure.

FIG. 15A is a flowchart of a method of operating the power converter with reduced power consumption in an interval I according to the present disclosure.

FIG. 15B is a flowchart of the method of operating the power converter with reduced power consumption during an interval II and an interval III according to the present disclosure.

### DETAILED DESCRIPTION

Reference will now be made to the drawing figures to describe the present disclosure in detail. It will be understood that the drawing figures and exemplified embodiments of present disclosure are not limited to the details thereof.

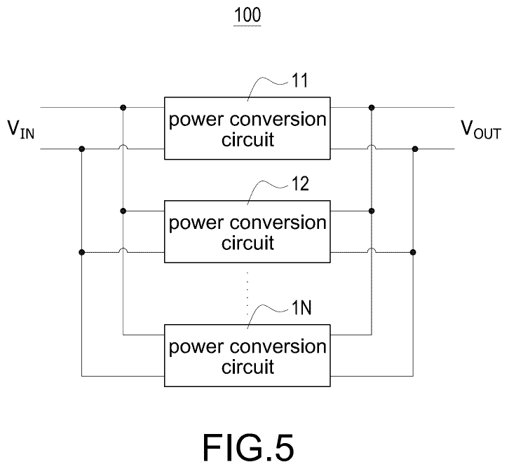

Please refer to FIG. 5, which shows a block structure diagram of a multi-phase power converter according to the present disclosure. The multi-phase (N-phase) power converter 100 converts an input power source V_{IN} into an output power source V_{OUT}. In particular, the input power source V_{IN} may be an alternating current (AC) power source or a direct current (DC) power source, and the output power source V_{OUT} may be an AC power source or a DC power source. That is, the multi-phase power converter 100 can be used for AC-to-DC conversion, DC-to-AC conversion, and DC-to-DC conversion.

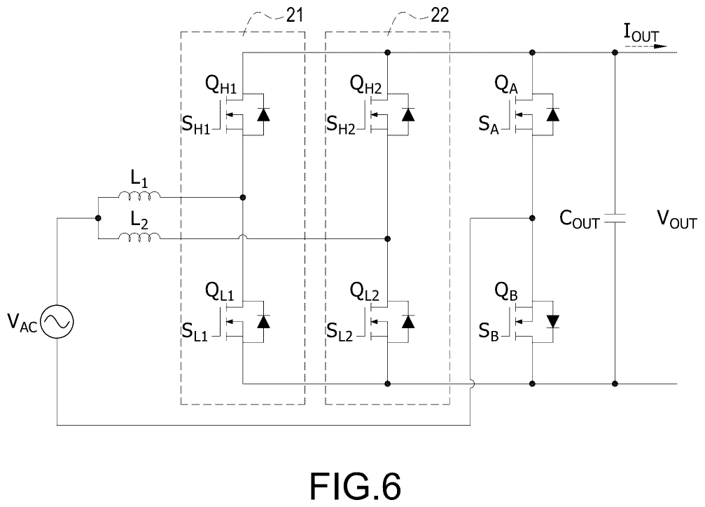

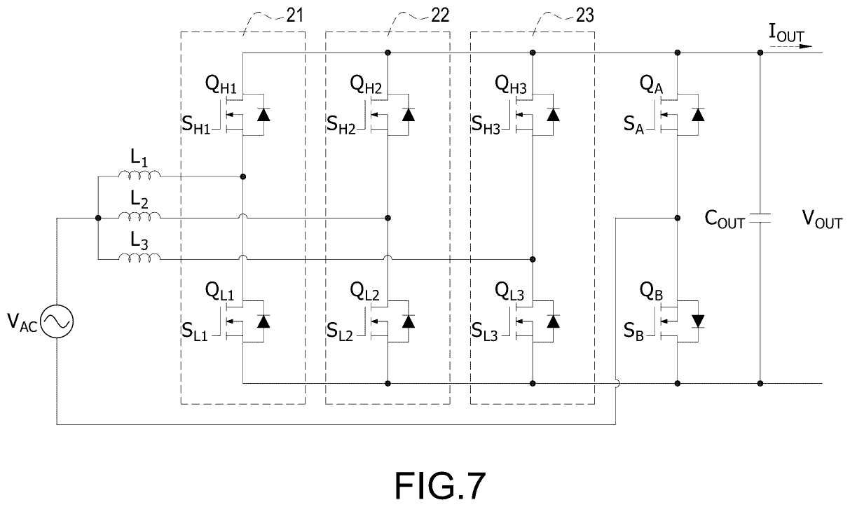

The multi-phase power converter 100 includes at least two power conversion circuits 11-IN, and the power conversion circuits 11-1N are connected in parallel to each other for an application of high output power so as to meet the increased power demand of large-scale information equipment. Please refer to FIG. 6 (which shows a circuit diagram of the multi-phase power converter having two switch bridge arms according to the present disclosure) or FIG. 7 (which shows a circuit diagram of the multi-phase power converter having three switch bridge arms according to the present disclosure), each power conversion circuit 11-1N, namely the power conversion circuit 21, 22, 23 includes switch bridge arms formed by upper switches Q_{H1}, Q_{H2}, Q_{H3} and lower switches Q_{L1}, Q_{L2}, Q_{L3} connected in series.

As shown in FIG. 6, the multi-phase power converter 100 is used for AC-to-DC conversion, that is, as a power factor corrector (PFC). The multi-phase power converter 100 includes two power conversion circuits 21, 22, that is, two switch bridge arms 21, 22 involving a first switch bridge arm 21 and a second switch bridge arm 22. The first switch bridge arm 21 includes a first upper switch Q_{H1} and a first lower switch Q_{L1} connected in series. The second switch bridge arm 22 includes a second upper switch Q_{H2} and a second lower switch Q_{L2} connected in series.

As shown in FIG. 7, the multi-phase power converter 100 is also used for AC-to-DC conversion, that is, as the power factor corrector (PFC). In comparison with the embodiment shown in FIG. 6, the multi-phase power converter 100 includes three power conversion circuits 21, 22, 23, that is, three switch bridge arms 21, 22, 23 involving a first switch bridge arm 21, a second switch bridge arm 22, and a third switch bridge arm 23. The first switch bridge arm 21 includes a first upper switch Q_{H1} and a first lower switch Q_{L1} connected in series. The second switch bridge arm 22 includes a second upper switch Q_{H2} and a second lower switch Q_{L2} connected in series. The third switch bridge arm 23 includes a third upper switch Q_{H3} and a third lower switch Q_{L3} connected in series.

In the application of the power factor corrector in FIG. 7, the first switch bridge arm 21, the second switch bridge arm 22, and the third switch bridge arm 23 are used as fast-switching bridge arms. In addition, the circuit structure further includes a slow-switching bridge arm, which includes a slow-switching upper switch Q_{A} and a slow-switching lower switch Q_{B} connected in series. The same is true for FIG. 6, so no further description is given.

Moreover, the multi-phase power converter 100 includes a control signal generation unit. In particular, the control signal generation unit is not limited to a specific form, for example, any controller, control circuit, etc. that can be used to generate signals for controlling the upper and lower switches of the switch arms should be included in the scope of the present disclosure. The control signal generation unit receives an output current I_{OUT} of the multi-phase power converter 100 to acquire a loading condition, such as a light-loading condition or a heavy-loading condition of the multi-phase power converter 100, and provides control signals for controlling the upper switches Q_{H1}, Q_{H2}, Q_{H3} and the lower switches Q_{L1}, Q_{L2}, Q_{L3}.

As shown in FIG. 6 and FIG. 7, the control signal generation unit provides a first upper switch control signal S_{H1} to control the first upper switch Q_{H1} of the first switch bridge arm 21, and provides a first lower switch control signal S_{L1} to control the first lower switch Q_{L1} of the first switch bridge arm 21. The control signal generation unit provides a second upper switch control signal S_{H2} to control the second upper switch Q_{H2} of the second switch bridge arm 22, and provides a second lower switch control signal S_{L2} to control the second lower switch Q_{L2} of the second switch bridge arm 22. As shown in FIG. 7, the control signal generation unit further provides a third upper switch control signal S_{H3} to control the third upper switch Q_{H3} of the third switch bridge arm 23, and provides a third lower switch control signal S_{L3} to control the third lower switch Q_{L3} of the third switch bridge arm 23.

Therefore, the control signal generation unit correspondingly turns on or turns off the upper switches Q_{H1}, Q_{H2}, Q_{H3} and the lower switches Q_{L1}, Q_{L2}, Q_{L3} according to the loading condition (based on the output current I_{OUT}) being a light-loading condition so that the at least two switch bridge arms are alternately driven. Taking the input power source V_{IN} as an AC power source (such as the AC power source V_{AC} in FIG. 6 and FIG. 7), the at least two switch bridge arms are alternately driven according to a time period of the AC power source V_{AC}. Incidentally, the control signal generation unit correspondingly turns on or turns off the upper switches Q_{H1}, Q_{H2}, Q_{H3} and the lower switches Q_{L1}, Q_{L2}, Q_{L3} according to the loading condition being a heavy-loading condition so that the at least two switch bridge arms are simultaneously driven.

The multi-phase power converter shown in FIG. 6 includes two switch bridge arms, that is the first switch bridge arm 21 and the second switch bridge arm 22 are alternately driven when a positive half cycle and a negative half cycle of the AC power source V_{AC}, namely the input power source V_{IN} are exchanged. In other words, when the AC power source V_{AC} is in the positive half cycle, the first upper switch control signal S_{H1} and the first lower switch control signal S_{L1} provided by the control signal generation unit respectively control the first upper switch Q_{H1} and the first lower switch Q_{L1} of the first switch bridge arm 21 to be alternately turned on and turned off. In this condition, only one phase, i.e., only the first switch bridge arm 21 operates, that is, the second switch bridge arm 22 is idle.

When the AC power source V_{AC} is in the negative half cycle, the second upper switch control signal S_{H2} and the second lower switch control signal S_{L2} provided by the control signal generation unit respectively control the second upper switch Q_{H2} and the second lower switch Q_{L2} of the second switch bridge arm 22 to be alternately turned on and turned off. In this condition, only one phase, i.e., only the second switch bridge arm 22 operates, that is, the first switch bridge arm 21 is idle.

However, the above-mentioned operation of the first switch bridge arm 21 and the second switch bridge arm 22 respectively in the positive half cycle and negative half cycle is not intended to limit the present disclosure. That is, when the AC power source V_{AC} is in the positive half cycle, the second switch bridge arm 22 is driven to operate (but the first switch bridge arm 21 is idle); when the AC power source V_{AC} is in the negative half cycle, the first switch bridge arm 21 is driven to operate (but the second switch bridge arm 22 is idle). Although the first switch bridge arm 21 and the second switch bridge arm 22 operate in different half cycles, the same technical effect can still be achieved.

Therefore, for the two switch bridge arms as shown in FIG. 6, since the two switch bridge arms are alternately driven (each is 50% of the turned-on time period), the power loss is also 50%, and the temperature of the transistor switch is also more uniform. In addition to the design that is helpful for heat dissipation and cooling, it is not prone to the problem of great difference in life due to unbalanced use time.

The multi-phase power converter shown in FIG. 7 includes three switch bridge arms, that is the first switch bridge arm 21, the second switch bridge arm 22, and the third switch bridge arm 23 are alternately driven at intervals of 120 degrees (360/3 degrees) of the AC power source V_{AC}, namely the input power source V_{IN}. For example, but not to limit the present disclosure, when the AC power source V_{AC} is in 0-degree electrical angle, the first upper switch control signal S_{H1} and the first lower switch control signal S_{L1} begin to be provided by the control signal generation unit respectively control the first upper switch Q_{H1} and the first lower switch Q_{L1} of the first switch bridge arm 21 to be alternately turned on and turned off. In this condition, only one phase, i.e., only the first switch bridge arm 21 operates, that is, the second switch bridge arm 22 and the third switch bridge arm 23 are idle.

When the AC power source V_{AC} is in 120-degree electrical angle, the second upper switch control signal S_{H2} and the second lower switch control signal S_{L2} begin to be provided by the control signal generation unit respectively control the second upper switch Q_{H2} and the second lower switch Q_{L2} of the second switch bridge arm 22 to be alternately turned on and turned off. In this condition, only one phase, i.e., only the second switch bridge arm 22 operates, that is, the first switch bridge arm 21 and the third switch bridge arm 23 are idle.

When the AC power source V_{AC} is in 240-degree electrical angle, the third upper switch control signal S_{H3} and the third lower switch control signal S_{L3} begin to be provided by the control signal generation unit respectively control the third upper switch Q_{H3} and the third lower switch Q_{L3} of the third switch bridge arm 23 to be alternately turned on and turned off. In this condition, only one phase, i.e., only the third switch bridge arm 23 operates, that is, the first switch bridge arm 21 and the second switch bridge arm 22 are idle.

However, the above-mentioned operation of the first switch bridge arm 21, the second switch bridge arm 22, and the third switch bridge arm 23 alternately driven at intervals of 120 degrees of the AC power source V_{AC} is not intended to limit the present disclosure. That is, after the first switch bridge arm 21 operates (but the second switch bridge arm 22 and the third switch bridge arm 23 are idle), the third switch bridge arm 23 continues to operate (but the first switch bridge arm 21 and the second switch bridge arm 22 are idle), and then the second switch bridge arm 22 continues to operate (but the first switch bridge arm 21 and the third switch bridge arm 23 are idle). Although the sequence of operating of the first switch bridge arm 21, the second switch bridge arm 22, and the third switch bridge arm 23 is different, the same technical effect can still be achieved.

Therefore, it can be seen from the above description that when the multi-phase power converter has N switch bridge arms, the N switch bridge arms are alternately driven at intervals of 360/N degrees of the AC power source V_{AC}.

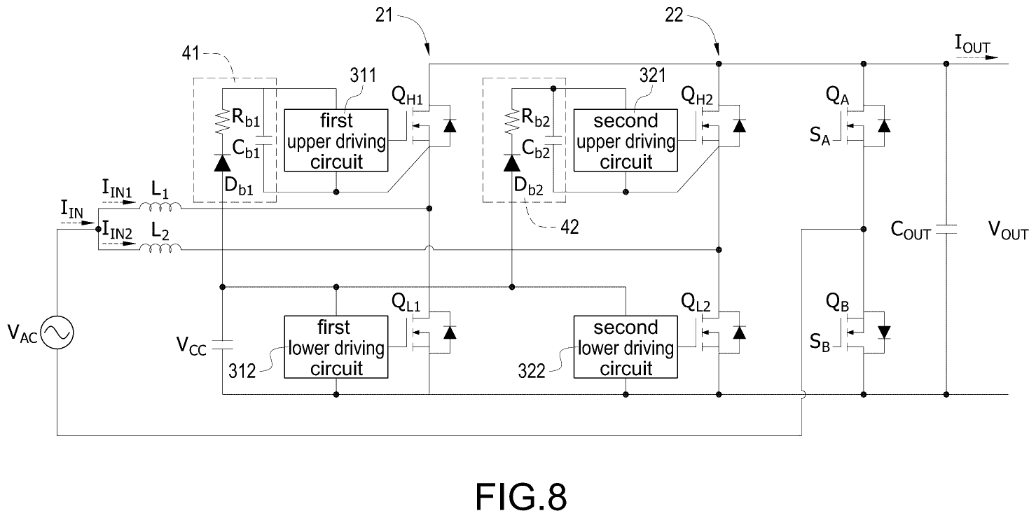

Please refer to FIG. 8, which shows a circuit diagram of the multi-phase power converter having a Totem-Pole power factor correction (PFC) circuit according to the present disclosure. The Totem-Pole PFC circuit includes a first switch bridge arm 21, a second switch bridge arm 22, a first upper driving circuit 311 and a first lower driving circuit 312, a second upper driving circuit 321 and a second lower driving circuit 322, a first bootstrap circuit 41, a second bootstrap circuit 42, and a DC driving voltage Vcc.

The first switch bridge arm 21 includes a first upper switch Q_{H1} and a first lower switch Q_{L1} connected in series. The second switch bridge arm 22 includes a second upper switch Q_{H2} and a second lower switch Q_{L2} connected in series. The first upper driving circuit 311 and the first lower driving circuit 312 respectively control the first upper switch Q_{H1} and the first lower switch Q_{L1}. The second upper driving circuit 321 and the second lower driving circuit 322 respectively control the second upper switch Q_{H2} and the second lower switch Q_{L2}.

The first bootstrap circuit 41 is coupled to the first upper driving circuit 311 and the first upper switch Q_{H1}. In this embodiment, the first bootstrap circuit 41 includes a first diode D_{b1}, a first current-limiting resistor R_{b1}, and a first capacitor C_{b1}. The first current-limiting resistor R_{b1} is connected to the first diode D_{b1} in series. The first capacitor C_{b1} is connected to the first current-limiting resistor R_{b1} and the first upper driving circuit 311.

The second bootstrap circuit 42 is coupled to the second upper driving circuit 321 and the second upper switch Q_{H2}. In this embodiment, the second bootstrap circuit 42 includes a second diode D_{b2}, a second current-limiting resistor R_{b2}, and a second capacitor C_{b2}. The second current-limiting resistor R_{b2} is connected to the second diode D_{b2} in series. The second capacitor C_{b2} is connected to the second current-limiting resistor R_{b2} and the second upper driving circuit 321.

The DC driving voltage Vcc supplies power required by the first upper driving circuit 311, the first lower driving circuit 312, the second upper driving circuit 321, and the second lower driving circuit 322.

The alternately driving of the first switch bridge arm 21 and the second switch bridge arm 22 at the light-loading condition is described as follows. When the AC power source V_{AC} is in the positive half cycle, the first switch bridge arm 21 is driven to operate, and the second switch bridge arm 22 is idle. In this condition, in addition to providing the power required by the first lower driving circuit 312 to maintain the first lower driving circuit 312 to normally control the first lower switch Q_{L1}, the DC driving voltage Vcc also supplies power to the first bootstrap circuit 41. Therefore, the DC driving voltage Vcc turns on the first diode D_{b1}, charges the first capacitor C_{b1}, and builds and maintains a first capacitor voltage on the first capacitor C_{b1} to provide the power required by the first upper driving circuit 311 so that the first upper driving circuit 311 can normally control the first upper switch Q_{H1}. In this embodiment, the first current-limiting resistor R_{b1} connected to the first diode D_{b1} in series is used to limit the magnitude of the current flowing through the series-connected branch.

When the AC power source V_{AC} is in the negative half cycle, the second switch bridge arm 22 is driven to operate, and the first switch bridge arm 21 is idle. In this condition, in addition to providing the power required by the second lower driving circuit 322 to maintain the second lower driving circuit 322 to normally control the second lower switch Q_{L2}, the DC driving voltage Vcc also supplies power to the second bootstrap circuit 42. Therefore, the DC driving voltage Vcc turns on the second diode D_{b2}, charges the second capacitor C_{b2}, and builds and maintains a second capacitor voltage on the second capacitor C_{b2} to provide the power required by the second upper driving circuit 321 so that the second upper driving circuit 321 can normally control the second upper switch Q_{H2}. In this embodiment, the second current-limiting resistor R_{b2} connected to the second diode D_{b2} in series is used to limit the magnitude of the current flowing through the series-connected branch.

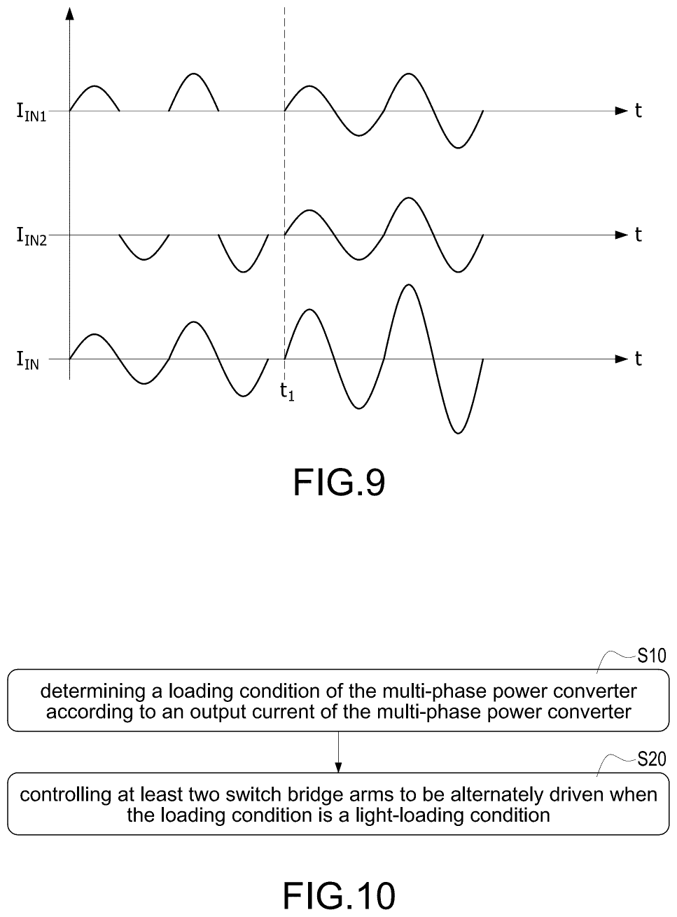

Please refer to FIG. 9, which shows a schematic current waveform diagram of alternately driving switch bridge arms of the multiple-phase power converter according to the present disclosure. Since the two switch bridge arms are alternately driven at the light-loading condition, the total harmonic distortion (THD) of the total input current I_{IN} summed by the first input current I_{IN1} and the second input current I_{IN2} is significantly reduced, and has excellent current quality.

As disclosed in FIG. 6 to FIG. 9 and the corresponding descriptions thereof, the multi-phase power converter 100 disclosed in the present disclosure is not limited to the AC-to-DC conversion, but can also be applied to a DC-to-DC conversion that the power conversion circuits 11-1N connected in parallel. The multi-phase power converter 100 is used for DC-to-DC conversion, and the input power source V_{IN} thereof is a DC power source. In order to keep the voltage of the first capacitor C_{b1} in the first bootstrap circuit 41 greater than the UVLO voltage of the first upper driving circuit 311 and keep the voltage of the voltage of the second capacitor C_{b2} in the second bootstrap circuit 42 greater than the UVLO voltage of the second upper driving circuit 321, each switch bridge arm 21, 22 (shown in FIG. 8 and in FIG. 6) or each switch bridge arm 21, 22, 23 (shown in FIG. 7) in the multi-phase power converter 100 has a fixed switching cycle. In particular, the switching cycle is positively related to the capacitances of the first capacitor C_{b1} and the second capacitor C_{b2}. That is, when the capacitances of the first capacitor C_{b1} and the second capacitor C_{b2} are larger, the fixed switching cycle is longer. In other words, when the input power source V_{IN} is a DC power supply, the switch bridge arms 21, 22, 23 are alternately driven in the fixed switching cycle so as to ensure that the first upper driving circuit 311 corresponding to the first upper switch Q_{H1} and the second upper driving circuit 321 corresponding to the second upper switch Q_{H2} operate normally. Incidentally, when the multi-phase power converter 100 can receive both the AC and DC input power V_{IN} and the multi-phase power converter 100 has N switch bridge arms, the N switch bridge arms are alternately driven at intervals of 360/N degrees of the AC power source V_{AC}.

Please refer to FIG. 10, which shows a flowchart of a method of controlling the multi-phase power converter according to the present disclosure. The multi-phase power converter 100 includes at least two power conversion circuits 11-1N, 21-23, and each power conversion circuit 11-1N includes a switch bridge arm formed by an upper switch Q_{H1}, Q_{H2}, Q_{H3} and a lower switch Q_{L1}, Q_{L2}, Q_{L3} connected in series. The method includes steps of: determining a loading condition of the multiple-phase power converter 100 according to an output current I_{OUT} of the multiple-phase power converter 100 (step S10). Afterward, controlling the at least two power conversion circuits to be alternately driven when the loading condition is a light-loading condition (step S20). Since the specific circuit structure and operation description have been detailed in the previous disclosure, no more details will be given here.

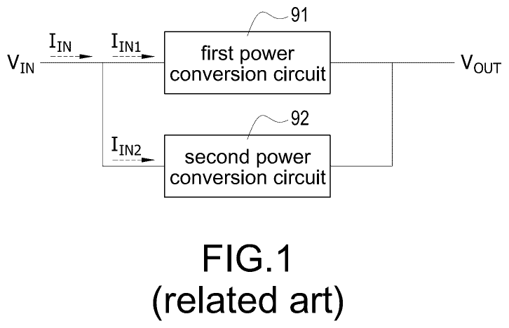

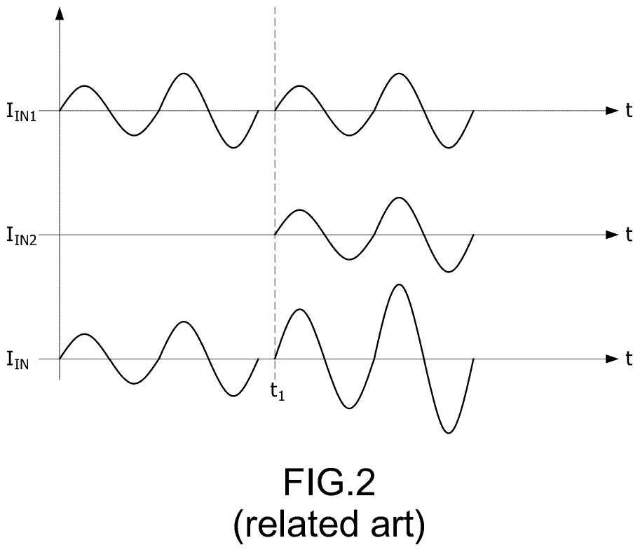

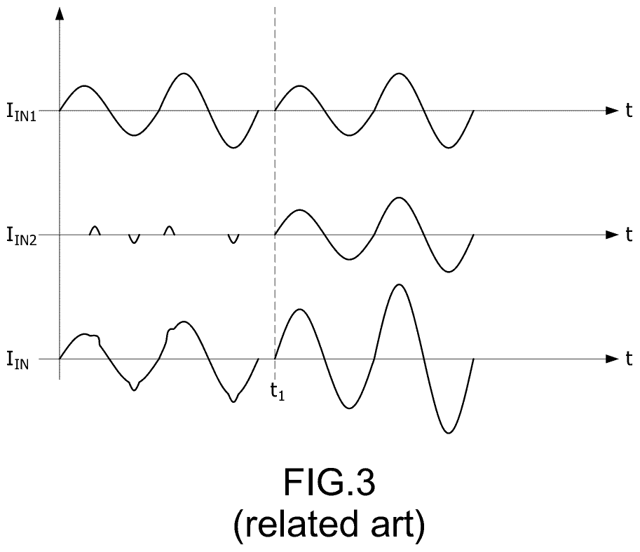

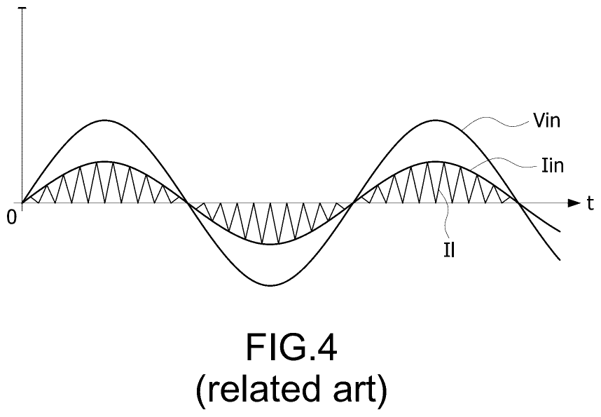

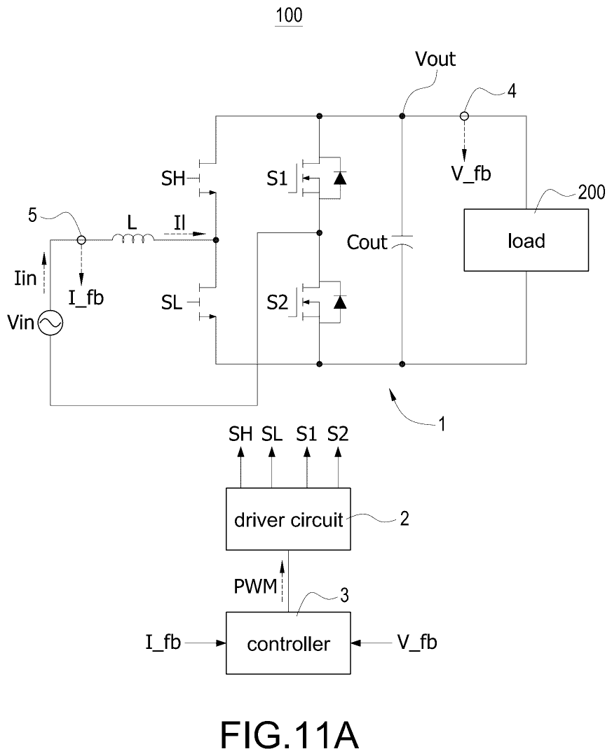

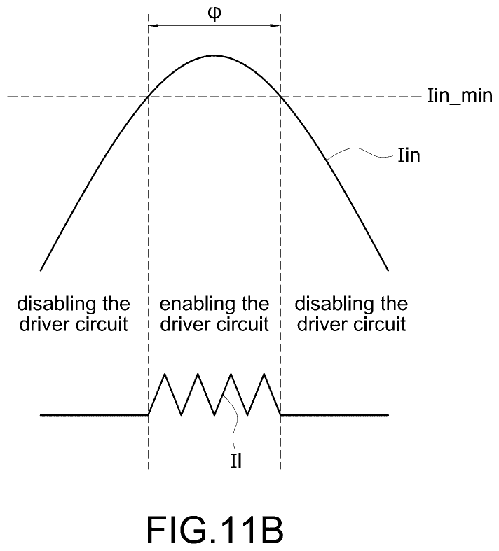

Please refer to FIG. 11A, which shows a block circuit diagram of a power converter with reduced power consumption according to the present disclosure, and also refer to FIG. 1. The power converter 100 (that is, each power conversion circuit 11-1N of FIG. 5) receives an input voltage Vin (that is, the input power source V_{IN} of FIG. 5) and provides an output voltage Vout (that is, the output power source V_{OUT} of FIG. 5) to supply power to a load 200. The power converter 100 includes a power factor correction circuit 1, a driver circuit 2, and a controller 3.

The power factor correction circuit 1 includes at least one inductor L, at least one switch (SH, SL, S1, S2, it may correspond to switches Q_{H1}, Q_{L1}, Q_{A}, Q_{B} or switches Q_{H2}, Q_{L2}, Q_{A}, Q_{B} in FIG. 6, and so on), and an output capacitor Cout. Take a circuit structure of FIG. 11A as an example, the inductor L is coupled at an input end of the power factor correction circuit 1 and receives the input voltage Vin. The output capacitor Cout is coupled at an output end of the power factor correction circuit 1 and coupled to the load 200 to provide the output voltage Vout to supply power to the load 200. The power switches (SH, SL, S1, S2) are coupled between the inductor L and the output capacitor Co, and the driver circuit 2 is coupled between the controller 3 and the power switches (SH, SL, S1, S2).

The power converter 100 further includes a voltage detection circuit 4 and a current detection circuit 5. The voltage detection circuit 4 is coupled between the output capacitor Cout and the controller 3, and the current detection circuit 5 is coupled between the power factor correction circuit 1 and the controller 3. The voltage detection circuit 4 detects the output voltage Vout to provide a first feedback voltage V_fb corresponding to the output voltage Vout to the controller 3. The current detection circuit 5 detects an input current Iin flowing through the input end of the power factor correction circuit 1 to provide a second feedback voltage I_fb corresponding to the input current Iin to the controller 3. The controller 3 modulates a PWM (pulse-width modulation) signal PWM based on the first feedback voltage V_fb and the second feedback voltage I_fb and provides the PWM signal PWM to the driver circuit 2.

The driver circuit 2 receives the PWM signal PWM and drives power switches (SH, SL, S1, S2) to switch turning on and turning off based on the PWM signal PWM. Therefore, the driver circuit 2 drives the switching of the power switches (SH, SL, S1, S2) based on the PWM signal PWM so as to control the power factor correction circuit 1 converting the input voltage Vin into the output voltage Vout. In one embodiment, the circuit structure of the power factor correction circuit 1 shown in FIG. 11A is only a schematic example. The power factor correction circuit 1 may use different circuit structures according to the requirements of the power converter 100. Therefore, all AC/DC conversion circuits that may be used as the power factor correction circuit 1 should be included in the scope of the present embodiment, and the detail description is omitted here for conciseness.

Please refer to FIG. 11B, which shows a schematic diagram of power consumption reduction of the power converter according to the present disclosure, and also refer to FIG. 11A.

With respect to the related art of FIG. 1, if the power factor correction circuit 1 can reach or near the highest (peak) point of the mains voltage (that is, the instantaneous voltage value of the input voltage Vin is the peak value), and then transfer the energy to the output end, not only the efficiency of the power factor correction circuit 1 can be increased, but also the driving loss of the power factor correction circuit 1 at no load or light load can be reduced. Therefore, the main purpose and function of the present disclosure is to provide a method for controlling the conduction phase angle interval φ of the input current Iin. The conduction phase angle interval φ takes the peak value of the input voltage Vin as the center to set the predetermined threshold Iin_min. When the load is light to a certain extent (i.e., no load or light load), the method of burst control of the output voltage Vout (i.e., the burst mode) is used to make the input current Iin reach near the peak value of the input voltage Vin so that when the input current Iin reaches near the peak value of the input voltage Vin, the driver circuit 2 is enabled, and the driver circuit 2 is disabled for the rest of the time.

Therefore, the controller 3 may only operate the switching of the power switches (SH, SL, S1, S2) when the driver circuit 2 is enabled so that the energy stored in the inductor L can be effectively transferred to the output capacitor Cout. In other words, when the input current Iin is greater than the predetermined threshold Iin_min, the inductor L generates the inductor current Il to transfer the energy stored in the inductor L to the output capacitor Cout, and during the period when the remaining input current Iin is lower than the predetermined threshold Iin_min, there is no generation of inductor current. Therefore, the energy transfer of the inductor L may be made more efficient, especially when the power factor correction circuit 1 is under no-load condition or light-load condition, and the input current Iin is not high, the effect is even more remarkable. Therefore, the power converter 100 and its operating method of the present disclosure can achieve the effect of increasing the efficiency of the power factor correction circuit 1 and reducing the driving loss of the power factor correction circuit 1 when it is under no-load operation or light-load operation.

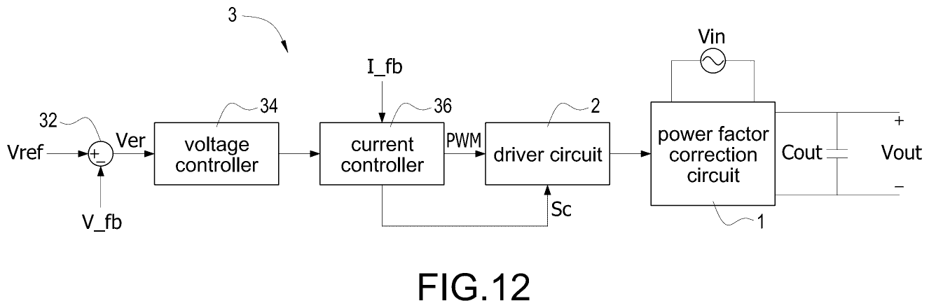

Please refer to FIG. 12, which shows a block circuit diagram of a controller according to the present disclosure, and also refer to FIG. 11A and FIG. 11B. The controller 3 includes an error amplifier 32, a voltage controller 34, and a current controller 36. The error amplifier 32 is coupled to the output capacitor Cout through the voltage detection circuit 4 to receive the first feedback voltage V_fb corresponding to the output voltage Vout. The error amplifier 32 generates an error signal Ver based on the first feedback voltage V_fb and a reference voltage Vref. The voltage controller 34 is coupled to the error amplifier 32 to receive the error signal Ver. The voltage controller 34 generates a voltage command Vc based on the error signal Ver. The current controller 36 is coupled to the voltage controller 34 to receive the voltage command Vc. The current controller 36 modulates and generates the PWM signal PWM to provide the PWM signal PWM to the driver circuit 2. Therefore, the frequency/duty ratio of the PWM signal PWM is mainly determined by the voltage command Vc, and the driver circuit 2 operates the switching of the power switches (SH, SL, S1, S2) based on the PWM signal PWM.

Furthermore, corresponding to the purpose and effect mentioned in the above, the current controller 36 is further coupled to the current detection circuit 5 to receive the second feedback voltage I_fb corresponding to the input current Iin. The current controller 36 generates a first current command Iin_rms_ref corresponding to an effective value of the input current Iin based on the second feedback voltage I_fb (corresponding to the input current Iin). The first current command Iin_rms_ref is proportional to the effective value of the input current Iin (that is, a root-mean-square value of the input current Iin), and is combined with the voltage command Vc as a DC current control command for the next cycle. The current controller 36 further generates a second current command Iin_ref corresponding to a current waveform of the input current Iin based on the second feedback voltage I_fb (corresponding to the input current Iin). The second current command Iin_ref is proportional to an instantaneous value of the input current Iin, and is combined with the voltage command Vc as an AC sinusoidal current control command for the next cycle. Based on conservation of energy, by sampling the output voltage Vout and the input current Iin, the loading of the back-end load 200 can be reflected, and therefore it can be determined whether the loading of the load 200 is at no load (light load), medium load, or heavy load. In addition, the controller 3 can preset parameters such as the current lower limit, the current upper limit, and the predetermined threshold based on the circuit specifications of the power factor correction circuit 1 for subsequent operation of the driver circuit 2.

Therefore, the current controller 36 can determine whether to enable or disable the driver circuit 2 by providing the control signal Sc through the voltage command Vc, the second feedback voltage I_fb, and the parameters set above. In one embodiment, the current lower limit, the current upper limit, and the predetermined threshold may preferably be preset by the current controller 36 based on the voltage command Vc, the second feedback voltage I_fb, and the circuit specifications of the power factor correction circuit 1, but not limited to this.

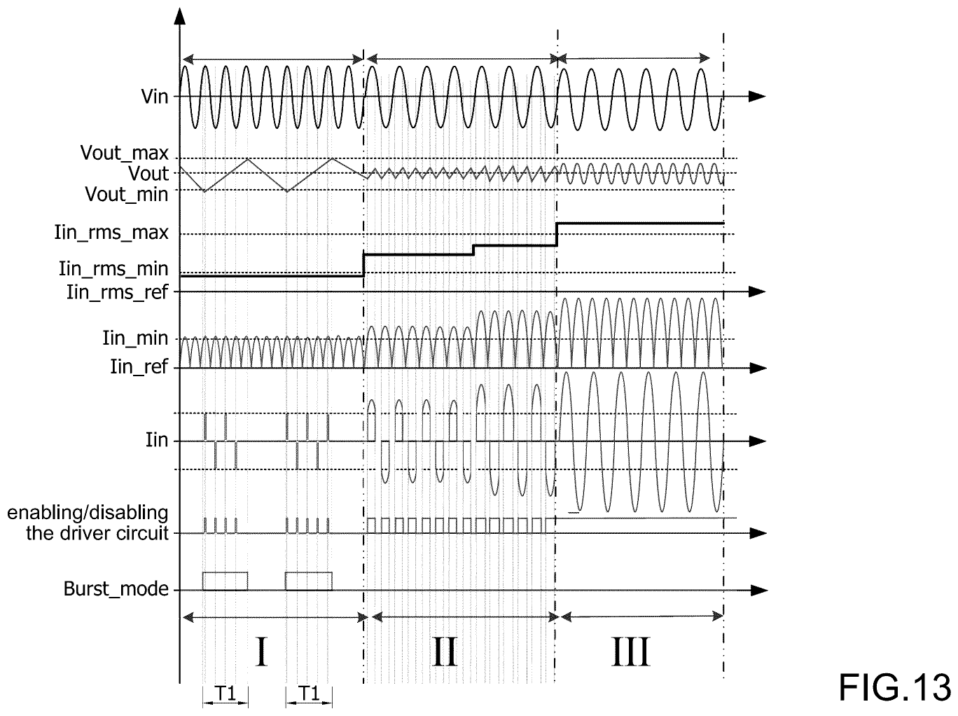

Please refer to FIG. 13, which shows an operation sequence diagram of the power converter according to the present disclosure, and also refer to FIG. 11A to FIG. 12. In FIG. 13, three intervals (I, II, III) are shown, and the three intervals respectively correspond to the timings when the power converter 100 operates at no load (light load), medium load, and heavy load. The controller 3 presets parameters such as the current lower limit Iin_rms_min, the current upper limit Iin_rms_max, and the predetermined threshold Iin_min based on the circuit specifications of the power factor correction circuit 1. The current controller 36 mainly determines whether the effective value of the input current Iin is correspondingly lower than the current lower limit Iin_rms_min through the first current command Iin_rms_ref, and determines whether the instantaneous value of the input current Iin is correspondingly greater than the predetermined threshold Iin_min so as to perform corresponding operations.

In the interval I, the current controller 36 determines that the effective value of the input current Iin of the power factor correction circuit 1 is correspondingly lower than the current lower limit Iin_rms_min based on the first current command Iin_rms_ref, that is, it indicates that the power factor correction circuit 1 operates under no-load condition or light-load condition. Therefore, the controller 3 operates in a burst mode. The operation of the burst mode is that the controller 3 controls the PWM signal PWM to generate pulses in a specific time period T1, and does not generate pulses in other time periods so that the power converter 100 save power consumption when operating in the no-load or the light-load condition. In one embodiment, the manner of setting the start/end of the specific time period T1 is based on the magnitude of the output voltage Vout. When the output voltage Vout reaches a voltage lower limit Vout_min, the specific time period T1 starts, and when the output voltage Vout reaches a voltage upper limit Vout_max, the specific time period T1 ends.

Also refer to FIG. 11B, in the specific time period T1, when the current controller 36 of the controller 3 determines that the instantaneous value of the input current Iin of the power factor correction circuit 1 is correspondingly greater than the predetermined threshold Iin_min through the second current command Iin_ref, the driver circuit 2 is enabled. When the driver circuit 2 is enabled, the driver circuit 2 drives the power switches (SH, SL, S1, S2) based on the pulse wave of the PWM signal PWM to operate the switching of the power switches (SH, SL, S1, S2) so that the energy stored in the inductor L is transferred to the output capacitor Cout. Conversely, when the current controller 36 determines that the instantaneous value of the input current Iin of the power factor correction circuit 1 is correspondingly lower than the predetermined threshold Iin_min through the second current command Iin_ref, the driver circuit 2 is disabled. Therefore, the pulse wave of the PWM signal PWM cannot drive the power switches (SH, SL, S1, S2) since the driver circuit 2 is disabled.

Furthermore, the current controller 36 of the controller 3 actually continuously generates the PWM signal PWM based on the voltage command Vc. Especially in the burst mode in the interval I, the PWM signal PWM is continuously generated only in the specific time period T1. That is, in the general burst mode, the pulse wave of the PWM signal PWM will actually be more than the pulse wave in the specific time period T1 in FIG. 13. In the general burst mode, besides the pulse wave located near the peak of the waveform of the input voltage Vin, the pulse wave located near the zero point of the waveform of the input voltage Vin is also included. However, as shown in FIG. 11B, when the load is light enough to a certain extent (i.e., no load or light load), the burst mode of the output voltage Vout is combined to make the input current Iin reach the peak value of the waveform of the input voltage Vin, and be greater than the predetermined threshold Iin_min, the driver circuit 2 is enabled. Therefore, in FIG.

13, only during the specific time period T1 and the input current Iin (current waveform) is correspondingly greater than the predetermined threshold Iin_min, the switching of the power switches (SH, SL, S1, S2) is operated to make the energy stored in the inductor L can be effectively transferred to the output capacitor Cout to correspondingly generate the input current Iin.

In the interval II, the current controller 36 determines that the effective value of the input current Iin of the power factor correction circuit 1 is between the current lower limit Iin_rms_min and the current upper limit Iin_rms_max through the first current command Iin_rms_ref, that is, it indicates that the power factor correction circuit 1 operates from no-load condition or light-load condition to medium-load condition. In this condition, the controller 3 leaves from the operation of the burst mode, the ripple of the output voltage Vout becomes smaller, and will no longer reach the voltage lower limit Vout_min and voltage upper limit Vout_max.

Since the controller 3 leaves from the operation of the burst mode, the enabling/disabling of the driver circuit 2 is no longer limited to the specific time period T1. When the current controller 36 of the controller 3 determines that the instantaneous value of the input current Iin of the power factor correction circuit 1 is correspondingly lower than the predetermined threshold Iin_min through the second current command Iin_ref, the driver circuit 2 is disabled, and the pulse wave of the PWM signal PWM cannot drive the power switches (SH, SL, S1, S2) since the driver circuit 2 is disabled. Conversely, when the current controller 36 determines that the instantaneous value of the input current Iin of the power factor correction circuit 1 is correspondingly greater than the predetermined threshold value Iin_min through the second current command Iin_ref, the driver circuit 2 is enabled. When the driver circuit 2 is enabled, the driver circuit 2 drives the power switches (SH, SL, S1, S2) based on the pulse wave of the PWM signal PWM to operate the switching of the power switches (SH, SL, S1, S2) so that the energy stored in the inductor L is transferred to the output capacitor Cout.

In the interval III, the current controller 36 determines that the effective value of the input current Iin of the power factor correction circuit 1 is correspondingly greater than the current upper limit Iin_rms_max through the first current command Iin_rms_ref, that is, it indicates that the power factor correction circuit 1 operates from medium-load condition to heavy-load condition. Since the power factor correction circuit 1 operates under heavy load, the energy required by the load 200 is relatively large so that the current controller 36 of the controller 3 continuously enables the driver circuit 2. The driver circuit 2 continuously drives the power switches (SH, SL, S1, S2) based on the pulse wave of the PWM signal PWM to operate the switching of the power switches (SH, SL, S1, S2) so that the energy stored in the inductor L is continuously transferred to the output capacitor Cout.

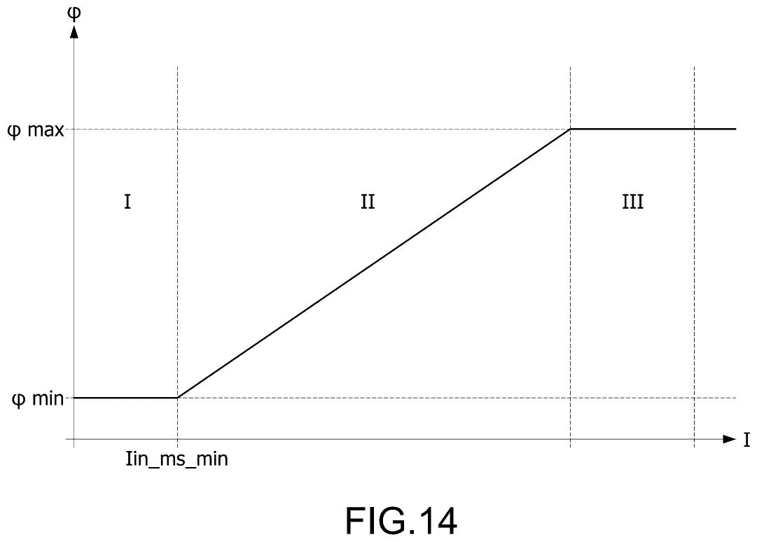

Please refer to FIG. 14, which shows a curve diagram of a conduction phase angle interval of an input current according to the present disclosure, and also refer to FIG. 11A to FIG. 13. The intervals I, II, and III in FIG. 14 correspond to the intervals I, II, and III in FIG. 13 respectively, and the curve in FIG. 14 refers to the width of the conduction phase angle interval φ in FIG. 11B. In the interval I, since the effective value of the input current Iin of the power factor correction circuit 1 is correspondingly lower than the current lower limit Iin_rms_min, the conduction phase angle interval φ is maintained at a minimum interval φmin. In the interval II, since the load gradually increases, the effective value of the input current Iin of the power factor correction circuit 1 is between the current lower limit Iin_rms_min and the current upper limit Iin_rms_max so that the conduction phase angle interval φ is between the minimum interval φmin and a maximum interval φmax. In the interval III, due to the heavy load, the effective value of the input current Iin of the power factor correction circuit 1 is correspondingly greater than the current upper limit Iin_rms_max so that the conduction phase angle interval φ is maintained at the maximum interval φmax. In particular, the maximum interval φmax usually refers to the interval in which the driver circuit 2 is continuously enabled, which means that the interval may be 180 degrees; the minimum interval φmin may be designed according to the specifications of the power factor correction circuit 1 (such as but not limited to 15 degrees).

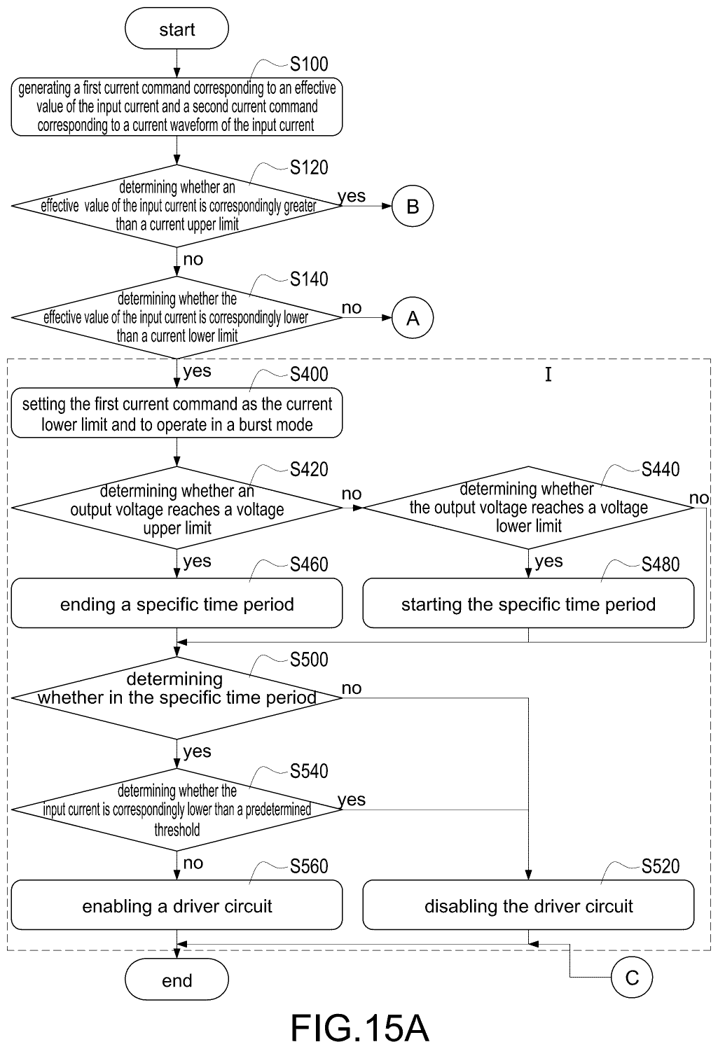

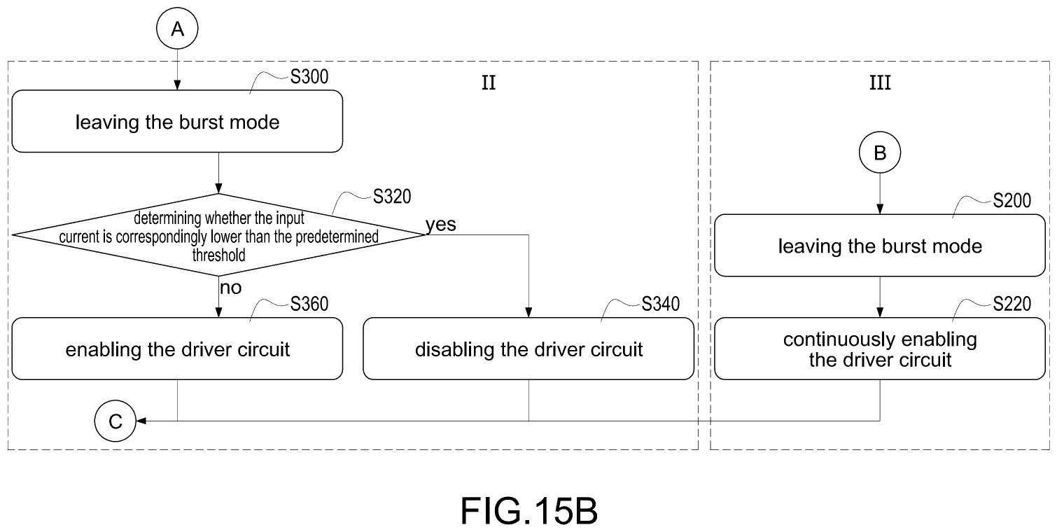

Please refer to FIG. 15A, which is a flowchart of a method of operating the power converter with reduced power consumption in an interval I according to the present disclosure; please refer to FIG. 15B, which is a flowchart of the method of operating the power converter with reduced power consumption during an interval II and an interval III according to the present disclosure, and also refer to FIG. 11A to FIG. 14. The present disclosure mainly uses a method of controlling the conduction phase angle interval φ of the input current Iin to control the power factor correction circuit 1. The driver circuit 2 is enabled only when the input current Iin reaches near the peak value of the waveform of the input voltage Vin, and the driver circuit 2 is disabled at other times. Therefore, the method of operating the power converter includes steps of generating a first current command corresponding to an effective value of the input current and a second current command corresponding to a current waveform of the input current (S100). In particular, the method of generating the first current command Iin_rms_ref and the second current command Iin_ref may be referred to FIG. 12, and the detail description is omitted here for conciseness.

Afterward, determining whether the effective value of the input current is correspondingly greater than a current upper limit (S120). When the effective value of the input current Iin is correspondingly greater than the current upper limit Iin_rms_max, the operation in the interval III in FIG. 13 is executed, and the operation of the burst mode leaves (S200) and the driver circuit is continuously enabled (S220). Detailed operations of the above steps may be referred to the interval III in FIG. 13 and FIG. 14, and the detail description is omitted here for conciseness. When the determination result in step (S120) is “NO”, step (S140) is then executed to determine whether the effective value of the input current is correspondingly lower than a current lower limit. When the effective value of the input current Iin is neither greater than the current upper limit Iin_rms_max nor lower than the current lower limit Iin_rms_min, that is, when the determination result in step (S140) is “NO”, the operation in the interval II in FIG. 13 is executed, and the operation of the burst mode leaves (S300).

Afterward, determining whether the input current is correspondingly lower than a predetermined threshold (S320). When the instantaneous value of the input current Iin (current waveform) of the power factor correction circuit 1 is correspondingly lower than the predetermined threshold Iin_min, the driver circuit is disabled (S340). The pulse wave of the PWM signal PWM cannot drive the power switches (SH, SL, S1, S2) since the driver circuit 2 is disabled. Conversely, when the instantaneous value of the input current Iin (current waveform) of the power factor correction circuit 1 is correspondingly greater than the predetermined threshold Iin_min, the driver circuit is enabled (S360). When the driver circuit 2 is enabled, the driver circuit 2 can drive the power switches (SH, SL, S1, S2) based on the pulse wave of the PWM signal PWM to operate the switching of the power switches (SH [symbol] SL [symbol] S1 [symbol] S2) through the PWM signal PWM so that the energy stored in the inductor L is continuously transferred to the output capacitor Cout.

Afterward, when the determination result in step (S140) is “YES”, step (S400) is then executed to set the first current command as the current lower limit and to operate in the burst mode. The reason for setting the first current command Iin_rms_ref to the current lower limit Iin_rms_min is to avoid the first current command Iin_rms_ref from being too low and causing the current controller 36 to malfunction. Afterward, determining whether the output voltage reaches a voltage upper limit (S420). When the output voltage Vout does not reach the voltage upper limit Vout_max, it is determined whether the output voltage reaches a voltage lower limit (S440). When the output voltage Vout reaches the voltage upper limit Vout_max, the specific time period ends (S460). When the output voltage Vout reaches the voltage lower limit Vout_min, the specific time period starts (S480).

Afterward, determining whether in the specific time period (S500). When it is determined that it is not in the specific time period T1, the driver circuit is disabled (S520), and the pulse wave of the PWM signal PWM cannot drive the power switches (SH, SL, S1, S2) since the driver circuit 2 is disabled. When it is determined that it is in the specific time period T1, it is determined whether the input current is correspondingly lower than the predetermined threshold (S540). When it is determined that the instantaneous value of the input current Iin (current waveform) of the power factor correction circuit 1 is correspondingly lower than the predetermined threshold Iin_min, step (S520) is then executed, and the pulse wave of the PWM signal PWM cannot drive the power switches (SH [symbol] SL [symbol] S1 [symbol] S2) since the driver circuit 2 is disabled. Conversely, when the determination result in step (S540) is “NO”, the driver circuit is enabled (S560). When the driver circuit 2 is enabled, the driver circuit 2 can drive the power switches (SH, SL, S1, S2) based on the pulse wave of the PWM signal PWM so as to operate the switching of the power switches (SH [symbol] SL [symbol] S1 [symbol] S2) through the PWM signal PWM so that the energy stored in the inductor L is continuously transferred to the output capacitor Cout. In one embodiment, the process steps not described in FIG. 15A and FIG. 15B may be referred to in conjunction with FIG. 12 to FIG. 14, and the detail description is omitted here for conciseness.

In summary, the present disclosure has the following features and advantages:

1. The driving circuit of the multi-phase power converter of the present disclosure uses a single power supply so that it is beneficial to the miniaturized circuit design and cost reduction.

2. The total harmonic distortion of the total input current is significantly reduced, which increases the current quality.

3. The multi switch bridge arms are driven alternately, and each with an average conduction/turned-on time so that the power loss is also average. Moreover, the temperatures of the switch transistors are more even. In addition to the design that helps with heat dissipation and cooling, it is also less likely to cause a large difference in life due to imbalance in usage time.

4. When the load is light to a certain extent (i.e., no load or light load), the method of burst control of the output voltage (i.e., the burst mode) is used to make the input current reach near the peak value of the input voltage so that when the input current reaches near the peak value of the input voltage, the driver circuit is enabled. Therefore, the controller may only operate the switching of the power switches when the driver circuit is enabled so that the energy stored in the inductor can be effectively transferred to the output capacitor. Especially when the power factor correction circuit is under no-load condition or light-load condition, and the input current is not high, the effect is even more remarkable. Therefore, the power converter and its operating method of the present disclosure can achieve the effect of increasing the efficiency of the power factor correction circuit and reducing the driving loss of the power factor correction circuit when it is under no-load operation or light-load operation.

Although the present disclosure has been described with reference to the preferred embodiment thereof, it will be understood that the present disclosure is not limited to the details thereof. Various substitutions and modifications have been suggested in the foregoing description, and others will occur to those of ordinary skill in the art. Therefore, all such substitutions and modifications are intended to be embraced within the scope of the present disclosure as defined in the appended claims.

What is claimed is:

1. A multi-phase power converter, configured to convert an input voltage into an output voltage to supply power to a load, comprising:
at least two power conversion circuits, each of which comprising a switch bridge arm formed by an upper switch and a lower switch connected in series;
a driver circuit, coupled to and configured to drive the upper switches and the lower switches of the power conversion circuits to convert the input voltage into the output voltage;
a controller, coupled to the driver circuit and configured to determine a loading condition of the multi-phase power converter according to at least one of an input current and an output current of the multi-phase power converter for providing control signals for the upper switches and the lower switches of the power conversion circuits;
wherein when the controller determines the loading condition is a heavy-loading condition, the controller configures the driver circuit to drive the power conversion circuits to simultaneously converter the input voltage into the output voltage; and
wherein when the controller determines the loading condition is not the heavy-loading condition, the controller configures the driver circuit to alternatively drive the power conversion circuits to converter the input voltage into the output voltage; the controller disables the driver circuit when the input current of the multi-phase power converter is lower than a predetermined threshold, and the controller enables the driver circuit to alternatively drive the power conversion circuits when the input current is greater than the predetermined threshold.

2. The multi-phase power converter as claimed in claim 1, wherein when an effective value of the input current of the multi-phase power converter is greater than a current upper limit, the controller determines the loading condition is the heavy-loading condition and accordingly configures the driver circuit to continuously drive the power conversion circuits to simultaneously converter the input voltage into the output voltage.

3. The multi-phase power converter as claimed in claim 1, wherein when an effective value of an input current of the multi-phase power converter is between a current upper limit and a current lower limit, the controller determines the loading condition is a medium-loading condition and accordingly enables the driver circuit to alternatively drive the power conversion circuits when the input current is greater than the predetermined threshold, and disable the driver circuit when the input current of the multi-phase power converter is lower than the predetermined threshold.

4. The multi-phase power converter as claimed in claim 1, wherein when an effective value of an input current of the multi-phase power converter is lower than a current lower limit, the controller determines the loading condition is a light-loading condition, the controller accordingly enables the driver circuit in a specific time period to alternatively drive the power conversion circuits when the input current is greater than the predetermined threshold, and disables the driver circuit outside the specific time period when the input current is lower than the predetermined threshold; wherein and the specific time period is defined as a time period in which the output voltage of the multi-phase power converter varies from a voltage lower limit to a voltage upper limit.

5. A method of controlling a multi-phase power converter, the multi-phase power converter comprising at least two power conversion circuits and a driver circuit, each of the power conversion circuits comprising a switch bridge arm formed by an upper switch and a lower switch connected in series, and the method comprising:
driving the upper switches and the lower switches of the power conversion circuits by the driver circuit to convert the input voltage into the output voltage;
determining a loading condition of the multi-phase power converter according to at least one of an input current and an output current of the multi-phase power converter for providing control signals for the upper switches and the lower switches of the power conversion circuits;
configuring the driver circuit to drive the power conversion circuits to simultaneously converter the input voltage into the output voltage when determining that the loading condition is a heavy-loading condition; and
configuring the driver circuit to alternatively drive the power conversion circuits to converter the input voltage into the output voltage when determining that the loading condition is not the heavy-loading condition; disabling the driver circuit when the input current of the multi-phase power converter is lower than a predetermined threshold; enabling the driver circuit to alternatively drive the power conversion circuits when the input current is greater than the predetermined threshold.

6. The method of controlling the multi-phase power converter as claimed in claim 5, further comprising:
determining the loading condition is the heavy-loading condition when an effective value of the input current of the multi-phase power converter is greater than a current upper limit and accordingly configuring the driver circuit to continuously drive the power conversion circuits to simultaneously converter the input voltage into the output voltage.

7. The method of controlling the multi-phase power converter as claimed in claim 5, further comprising:
determining the loading condition is a medium-loading condition when an effective value of an input current of the multi-phase power converter is between a current upper limit and a current lower limit and accordingly enabling the driver circuit to alternatively drive the power conversion circuits when the input current is greater than the predetermined threshold and disabling the driver circuit when the input current of the multi-phase power converter is lower than the predetermined threshold.

8. The method of controlling the multi-phase power converter as claimed in claim 5, further comprising:
determining the loading condition is a light-loading condition when an effective value of an input current of the multi-phase power converter is lower than a current lower limit, accordingly enabling the driver circuit in a specific time period to alternatively drive the power conversion circuits when the input current is greater than the predetermined threshold, and disabling the driver circuit outside the specific time period when the input current is lower than the predetermined threshold;
wherein the specific time period is defined as a time period in which the output voltage of the multi-phase power converter varies from a voltage lower limit to a voltage upper limit.
